(19) United States
(12) Patent Application Publication
(10) Pub. No.: US 2010/0066700 A1
(43) Pub. Date: Mar. 18, 2010

(54) Capacitive Touch Screen

(75) Inventor: Larry Mozdzyn, Garland, TX (US)

Correspondence Address: MARTIN & ASSOCIATES, LLC, P O BOX 548, CARTHAGE, MO, 64836-0548, US

(73) Assignee: OCULAR LCD INC., Richardson, TX (US)

(21) Appl. No.: 12/210,140

(22) Filed: Sep. 12, 2008

(51) Int. Cl. G06F 3/044

(52) U.S. Cl. 345/174

(57) ABSTRACT

A capacitive touch screen has fewer manufacturing steps to reduce the cost of manufacture. The touch screen has ITO conductor traces that are resistance matched to maintain the accuracy of the touch screen while reducing the cost of manufacture. In addition, offset pattern printing is used to apply an optically matched insulative coating over the conductive traces to eliminate the need for other process steps to connect the conductive traces for the capacitive sense lines.

### BACKGROUND

1. Technical Field

The disclosure and claims herein generally relate to an improved capacitive touch screen, and more specifically relate to an improved capacitive touch screen with fewer manufacturing steps to reduce the cost of manufacture.

2. Background Art

Touch screens have become an increasingly important input device. Touch screens use a variety of different touch detection mechanisms. One important type of touch screen is the capacitive touch screen. Capacitive touch screens are manufactured via a multi-step process. In a typical touch screen process, a transparent conductive coating, such as indium tin oxide (ITO) is formed into conductive traces on two surfaces of glass. The conductive traces on the two surfaces of glass form a grid that can sense the change in capacitance when a user's finger touches the screen.

The conductive traces that form the grid need to have a uniform resistance to accurately sense the change in capacitance and get optimal touch performance. In the prior art, the conductive traces of ITO do not have a uniform resistance where the longer traces have more resistance than the shorter ones. To balance the resistance, the cured substrate is screen printed with a conductive material such as a silver conductive ink or with copper conductors to provide increased conductivity for the ITO conductors on the portion of the glass outside the viewing area of the screen. This adds additional steps to the process.

In the prior art, after forming the ITO conductors or traces on the bottom glass, the capacitive sense conductors are inter-connected by the process of screen printing in selective areas a combination of insulating and conductive traces such as silver ink. This process of screen printing insulating and conductive traces to connect the capacitive sense conductors requires several additional processing steps that increases the cost and complexity of the touch screen. Further, the prior art screen printing process is done with materials that do not provide an insulating layer over the ITO traces that is optically matched to the ITO traces in the viewing area of the touch screen, where an optically matched insulating layer would make the ITO traces invisible. In the prior art, the connection of the capacitive sense conductors was accomplished by screen printing an insulating layer of epoxy or acrylic material. This layer provided insulation over just those areas of the ITO traces where the conductive ink would be applied to connect the capacitive sense lines. The conductive ink layer is then applied over this insulating layer. An over-coat insulating layer over the entire area is then applied. This over-coat insulating layer is not optically matched to the ITO traces so the ITO traces are somewhat visible. Since the over-coat layer in the prior art is over the conductive ink, the over-coat layer cannot be a material that requires a high temperature cure process such as silicon dioxide, which is optically matched to the ITO traces.

Without a way to more efficiently manufacture a capacitive touch screen, manufacturers will not be able to fully utilize the touch screen in many applications.

### BRIEF SUMMARY

The application and claims herein are directed to an improved capacitive touch screen with fewer manufacturing steps to reduce the cost of manufacture. The touch screen has ITO conductor traces that are resistance matched to maintain the accuracy of the touch screen while reducing the cost of manufacture. In addition, offset pattern printing is used to apply an optically matched insulative coating over the conductive traces to eliminate the need for other process steps to connect the conductive traces for the capacitive sense lines.

The description and examples herein are directed to a capacitive touch screen that utilizes two pieces of glass, but the claims herein expressly extend to other arrangements including a single glass substrate.

The foregoing and other features and advantages will be apparent from the following more particular description, and as illustrated in the accompanying drawings.

### BRIEF DESCRIPTION OF DRAWINGS

The disclosure will be described in conjunction with the appended drawings, where like designations denote like elements, and:

FIG. 1 is a side view of a capacitive touch screen as claimed herein;

FIG. 2 is a bottom view of the top glass of a capacitive touch screen;

FIG. 3 shows a portion of the top glass of the capacitive touch screen in FIG. 2;

FIG. 4 shows a bottom view of the bottom glass of the capacitive touch screen;

FIG. 5 shows the bottom view of an insulative pattern applied to the bottom glass show in FIG. 4;

FIG. 6 shows the bottom view of the bottom glass show in FIG. 4 with a conductive ink layer applied on the insulative layer;

FIG. 7 is a method flow diagram that illustrates a method for manufacturing a touch screen according to the prior art; and

FIG. 8 is a method flow diagram that illustrates a method for manufacturing a touch screen as shown in FIGS. 1-6.

### DETAILED DESCRIPTION

The description and claims herein are directed to an improved capacitive touch screen with fewer manufacturing steps to reduce the cost of manufacture. The touch screen has ITO conductor traces that are resistance matched to maintain the accuracy of the touch screen while reducing the cost of manufacture. In addition, offset pattern printing is used to apply an optically matched insulative coating over the conductive traces to eliminate the need for other process steps to connect the conductive traces for the capacitive sense lines.

The touch screen's optical performance can be improved by over-coating the ITO traces within the touch screen viewing area with a silicon dioxide coating which has a refractive index between ITO and the glass substrate material used for the touch panel. The silicone dioxide coating will reduce the visibility of the ITO traces resulting in a more desired overall optical performance. Additionally an insulation layer of silicon dioxide provides electrical insulation of selected traces within the touch screen in order to prevent shorting of traces. The silicon dioxide coating has the properties of high electrical resistance and can therefore be used an electrical insulator. The silicone dioxide layer is also optically matched to the ITO traces to make them invisible to the user. Additionally, there are connection points on the ITO traces within the design that must not be over coated with insulating layer such as the connection points for the capacitive sense lines. By applying silicon dioxide using an offset pattern printing process a single printing process step can be used to create the improved optical performance of the touch screen, provide insulating properties needed for the design as well as provide electrical access points for electrical connections to the ITO traces. The offset printing process used herein is typically used in the prior art for making liquid crystal displays (LCDs) and not for capacitive touch screens. The offset printing process can apply a thin layer of silicon dioxide. In contrast, the screen printing process of the prior art applies a much thicker layer than what is required for applying a layer of silicon dioxide. The silicon dioxide layer provides insulation for the later applied conductive ink and at the same time an optically matched layer over the ITO traces. The high temperature cure for the silicone dioxide is then done before the application of the conductive ink so it is compatible with the later processes for the touch screen.

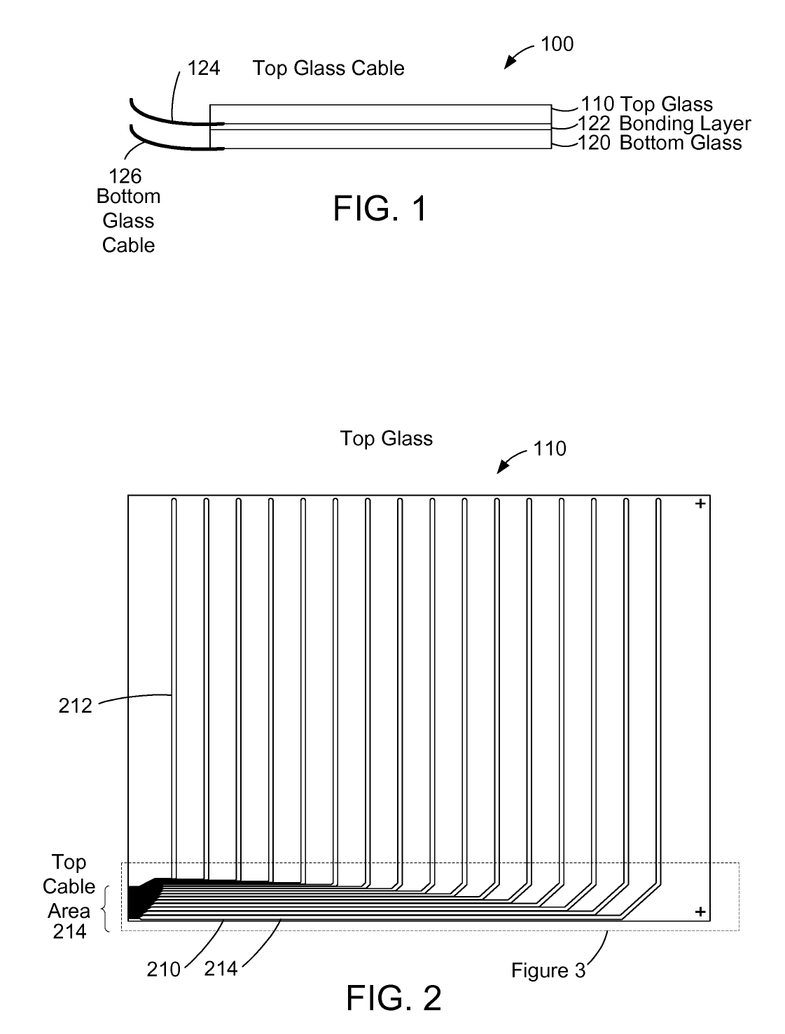

FIG. 1 shows a simplified side view of a touch screen 100. The touch screen 100 has a top glass 110 and a bottom glass 120. The top glass 110 is bonded to the bottom glass 120 with a bonding layer 122. The top glass 110 has a top glass cable 124 that connects to conductive traces (not shown) on a portion of the bottom surface of the top glass 110. Similarly, bottom glass 120 has a bottom glass cable 126 that connects to conductive traces (not shown) on a portion of the bottom surface of the bottom glass 110. Alternatively, the conductive traces and the cables could be connected to the top side (not shown) on one or both pieces of glass. The conductive traces and other materials applied to the glass are not shown in this drawing for simplicity but are described further below.

FIG. 2 illustrates a bottom view of the top glass 110 after forming conductive traces 210 on the bottom surface of the top glass 110. The conductive traces are formed of a conductive material such as indium tin oxide (ITO). The conductive traces 210 have a first section 212 in the viewing area of the touch screen and a second section 214 that typically will be placed outside the viewing area of the touch screen. The conductive traces 110 may be formed as known in the prior art. The typical prior art process includes the step of: forming an ITO layer on the glass, cleaning the glass, coating with photo resist, using ultra-violet light to expose the trace pattern on the resist, developing the photo resist, etching the ITO layer, removing the photo resist, and then cleaning the ITO layered glass. After these steps the top glass 110 appears as shown in FIG. 2.

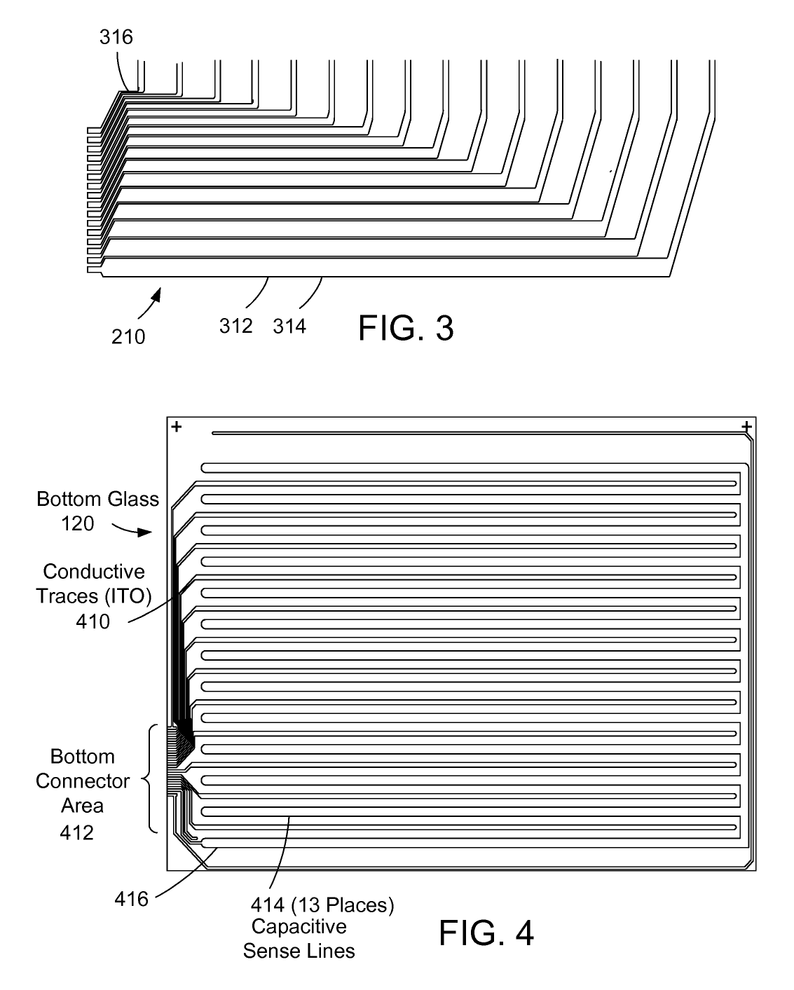

Again referring to FIG. 2, each of the conductive traces 210 terminate in the area of the top cable area 214 where the top glass cable will be connected in the manner known in the prior art and as illustrated in FIG. 1. The conductive traces on the top glass 110 are in the vertical direction and the conductive traces on the bottom glass 120 are perpendicular and lie in a horizontal plane as shown in FIG. 4. When the two pieces of glass are bonded together, the traces on the two pieces of glass form a grid that allows the electrical circuits (not shown) that drive the conductive traces to sense the location where the glass is touched. There are various ways known in the prior art to sense the location where the screen is touched.

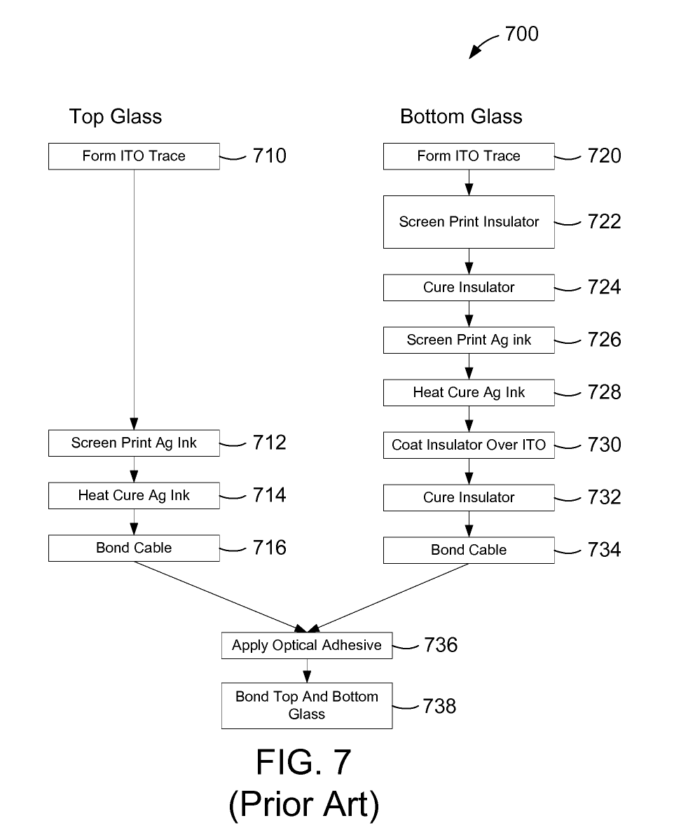

It is important to match the resistance of the conductor traces to maintain the accuracy of the touch screen. In the prior art, matching the resistance is typically done by applying a conductive ink over the conductor traces on areas outside the viewing areas. These prior art methods are more costly due the additional process steps (see FIG. 7). In contrast, FIGS. 2 and 3 illustrate ITO conductor traces 210 that are resistance matched so that each of the conductor traces have substantially the same overall resistance. The resistance matching is done in the on a section of the traces that is outside the viewing area of the touch screen since the traces inside the viewing area of the screen must be the same thickness for proper screen operation. The lower portion of FIG. 2 is reproduced on a larger scale in FIG. 3 to more clearly show this feature. Referring to FIG. 3, the conductor traces 210 are resistance matched by scaling the thickness of the horizontal portion 312 of the conductor trace so that the resistance of the horizontal portions of the conductor traces are substantially the same. Thus, the longest conductor trace 314 has the largest width, and the shortest conductor trace 316 has the smallest width.

FIG. 4 illustrates the bottom side of the bottom glass 120. The bottom glass 120 has conductive traces 410 of ITO in the horizontal direction. The horizontal conductive traces 410 together with the vertical traces of the top glass described above form a grid pattern. The conductive traces are gathered together in the bottom connector area 412 where a bottom glass cable 126 (FIG. 1) connects to the conductive traces 410 on the bottom glass 120. In addition, the bottom glass 120 has a set of capacitive sense lines 414 also formed of ITO that are interdispersed with the conductive traces 410. The capacitive sense lines 414 are all connected together on the right hand side of the drawing and the bottom sense line 416 extends to the bottom connector area 412 to connect to the bottom glass cable 126 (FIG. 1). The capacitive sense lines 414 are driven by the touch screen electronics (not shown) to sense the change in capacitance in the manner taught in the prior art. The portion of the conductive traces in the vertical direction may also be resistance balanced in the manner described above with reference to the top glass and shown in FIG. 3. However, since the bottom glass requires adding the conductive ink layer to connect the capacitive sense lines, using resistance balanced ITO traces does not save manufacturing steps for the bottom glass.

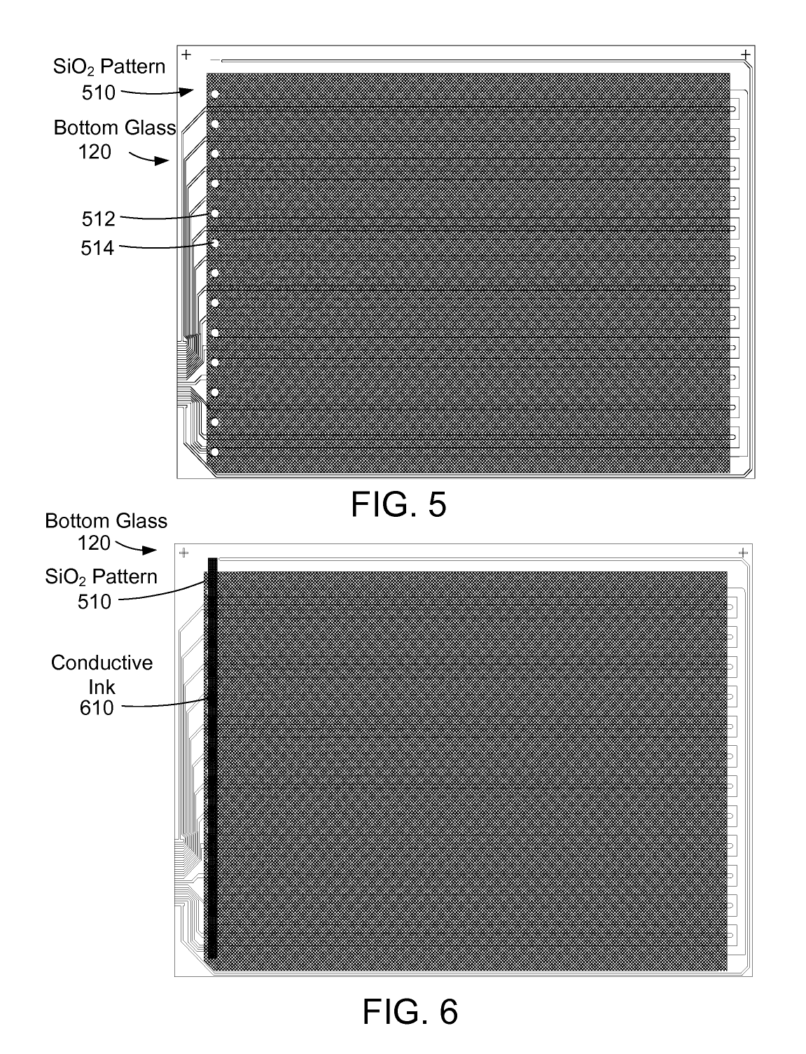

FIG. 5 further illustrates the bottom side of the bottom glass 120. FIG. 5 shows the bottom side of the bottom glass 120 after pattern offset printing a SiO₂ pattern 510 over the conductive traces 410 as shown in FIG. 4. The SiO₂ pattern 510 provides an insulative layer over the conductive traces that is optically matched to the glass and the ITO of the conductive traces. Further, the SiO₂ pattern 510 has a series of openings 512 that open to the ends 514 of the capacitive sense lines 414 (better observed in FIG. 4).

FIG. 6 again illustrates the bottom side of the bottom glass 120. FIG. 6 shows the bottom side of the bottom glass 120 after applying a pattern of conductive material such as conductive silver ink 610 over the openings 512 shown in FIG. 5. The silver ink 610 provides electrical connection of the capacitive sense lines 414 (FIG. 4) on the left hand side that is needed by the touch screen electronics to accurately sense the change in capacitance on the grid of conductive traces. The SiO₂ pattern 510 provides electrical insulation between the conductive ink 610 and the conductive traces 410 (FIG. 4).

FIG. 7 shows a method 700 for a touch screen according to the prior art. In summary, the method first performs several steps to form layers on a top glass, then several steps to form layers on a bottom glass, and then bonds the two pieces of glass together. The method begins by forming an ITO trace on the top glass (step 710) and then screen printing a layer of silver ink (step 712). In the prior art, this layer of silver ink is required to reduce the resistance of the longer ITO traces to balance the resistance. The silver ink layer is then cured (step 714) and the cable is bonded to the top glass (step 716). The method continues by forming an ITO trace on the bottom glass (step 720) and then screen printing an insulator on the ITO trace in the area where the connections to the capacitive sense lines will be made (step 722). The insulator is then cured (step 724) and a silver ink layer is printed to electrically connect the capacitive sense lines (step 726). The silver ink layer is cured (step 728) and an insulator coat is applied over the ITO conductive traces (step 730). The insulator is cured (step 732) and the bottom glass cable is bonded to the glass (step 734). An optical adhesive is applied between the two glass layers (step 736) and then top and bottom glasses are bonded together (step 736). The method is done.

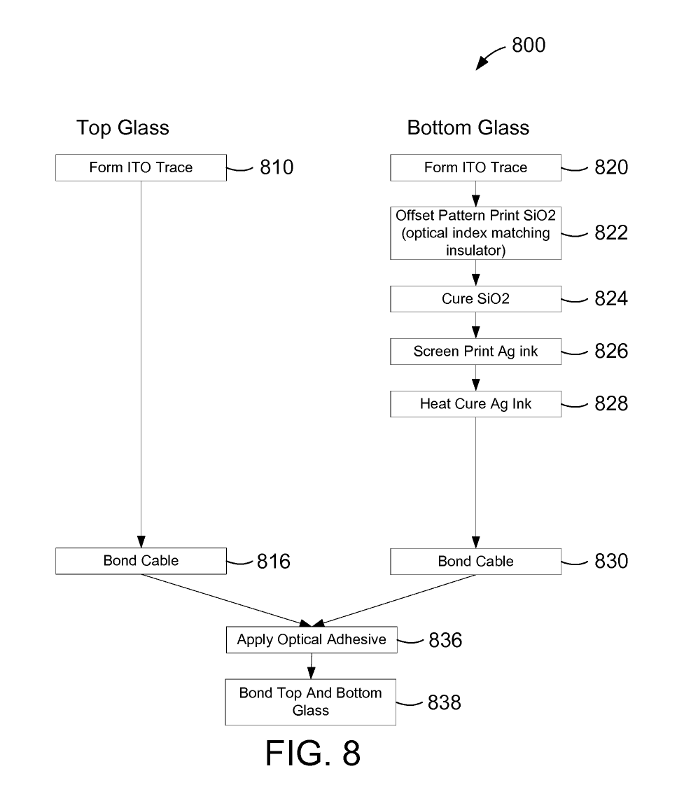

FIG. 8 shows a method 800 for a producing a touch screen as described herein. In summary, the method first performs several steps to form layers on a top glass, then several steps to form layers on a bottom glass, and then the two pieces of glass are bonded together. The method begins by forming an ITO trace on the top glass (step 810) and the top cable is bonded to the top glass (step 816). The method continues by forming an ITO trace on the bottom glass (step 820) and then offset pattern printing an insulator such as SiO₂ on the ITO conductive trace (step 822). The insulator is then cured (step 824) and a silver ink layer is printed to connect the capacitive sense lines (step 826). The silver ink layer is cured (step 828) and the bottom glass cable is bonded to the glass (step 830). An optical adhesive is applied between the two glass layers (step 836) and then top and bottom glasses are bonded together (step 838). The method is done.

One skilled in the art will appreciate that many variations are possible within the scope of the claims. Thus, while the disclosure has been particularly shown and described above, it will be understood by those skilled in the art that these and other changes in form and details may be made therein without departing from the spirit and scope of the claims.

What is claimed is:

1. A capacitive touch screen comprising:
a first plurality of conductive traces formed on a first glass surface;
a plurality of capacitive sense lines between the first plurality of conductive traces;
an optically matched insulating layer of silicone dioxide formed over the first plurality of conductive traces with a plurality of openings that expose ends of the plurality of capacitive sense lines; and
a conductive layer over the insulating layer that connects to the ends of the plurality of capacitive sense lines through the plurality of openings.

2. The capacitive touch screen of claim 1 further comprising a second plurality of conductive traces formed on a second glass surface terminating at a cable connection area, wherein the second plurality of conductive traces have a first section that is in a viewing area of the touch screen with the same width for each trace and perpendicular to the first plurality of conductive traces, and a second section of the second plurality of conductive traces that connect the first section to a cable connection area, wherein the second plurality of conductive traces have different trace widths in the second section such that the second plurality of conductive traces have a matched electrical resistance, and wherein the second plurality of conductive traces have the same width in the first section.

3. The capacitive touch screen of claim 2 wherein the first and second plurality of conductive traces are formed of indium tin oxide (ITO).

4. The capacitive touch screen of claim 2 wherein the insulative layer is applied over the first set of conductive traces by offset printing a pattern of SiO₂.

5. The capacitive touch screen of claim 2 wherein the second section of the second plurality of conductive traces is outside the viewing area of the touch screen.

6. The capacitive touch screen of claim 1 wherein the conductive layer is a silver conductive ink.

7. The capacitive touch screen of claim 1 wherein the first glass surface is on a first piece of glass and the second glass surface is on a second piece of glass.

8. A capacitive touch screen comprising:
a plurality of conductive traces formed on a piece of glass terminating at a cable connection area, wherein the plurality of conductive traces have a first section and a second section, where the second section is perpendicular to the first section and connects the first section to a cable connection area,
wherein the plurality of conductive traces have different trace widths in the second section such that the second plurality of conductive traces have a matched electrical resistance; and
wherein the first section is inside the viewing area of the touch screen the second section of the plurality of conductive traces is outside a viewing area of the touch screen.

9. The capacitive touch screen of claim 8 wherein the plurality of conductive traces are formed of indium tin oxide (ITO).

10. A method for manufacturing a touch screen, the method comprising the steps of:
a. forming a first plurality of conductive traces and a plurality of capacitive sense lines between the first plurality of conductive traces on a first glass surface;
b. offset printing an insulating layer of SiO₂ over the first plurality of conductive traces with a plurality of openings that expose ends of the plurality of capacitive sense lines;
c. screen printing a conductive silver ink layer over the insulating layer that connects to the ends of the plurality of capacitive sense lines through the plurality of openings;
d. curing the silver ink layer; and
e. bonding a connector cable to the ITO traces on the glass.

11. The method of claim 10 further comprising the steps of:
f. forming a second ITO trace with a plurality of conductive traces on a second glass surface terminating at a cable connection area, and
g. wherein the second plurality of conductive traces have a first section that is in a viewing area of the touch screen with the same width for each trace and perpendicular to the first plurality of conductive traces, and a second section of the second plurality of conductive traces that connect the first section to a cable connection area, wherein the second plurality of conductive traces have different trace widths in the second section such that the second plurality of conductive traces have a matched electrical resistance, and wherein the second plurality of conductive traces have the same width in the first section; and
h. bonding a connector cable to the ITO traces on the second glass surface.

12. The method of claim 10 further comprising the steps of bonding a first piece of glass having the first glass surface to a second piece of glass having the second glass surface.

13. The method of claim 10 wherein the first and second plurality of conductive traces are formed of indium tin oxide (ITO).

14. The method of claim 10 wherein the insulative layer is applied over the first set of conductive traces by offset printing a pattern of SiO₂.

15. The method of claim 10 wherein the second section of the second plurality of conductive traces is outside the viewing area of the touch screen.

16. The method of claim 10 wherein the conductive layer is a silver conductive ink.

17. The method of claim 10 wherein the first glass surface is on a first piece of glass and the second glass surface is on a second piece of glass.
